(19) United States
(12) Patent Application Publication
(10) Pub. No.: US 2023/0339618 A1
(43) Pub. Date: Oct. 26, 2023

(54) INTELLIGENT EVACUATION GUIDANCE SYSTEM

(71) Applicant: B/E AEROSPACE, INC., Winston Salem, NC (US)

(72) Inventors: NAKUL GUPTA, Dwarka (IN); PRIYANK ANAVADIYA, Bangalore (IN); SINDHU THOMAS, Bangalore (IN); VINAY CHULLIYIL NARAYANAN NAIR, Malappuram (IN); YASWANTH KUMAR MADDALI, Bangalore (IN)

(73) Assignee: B/E AEROSPACE, INC., Winston Salem, NC (US)

(21) Appl. No.: 17/889,299

(22) Filed: Aug. 16, 2022

(30) Foreign Application Priority Data
Apr. 25, 2022 (IN) 202241024127

(51) Int. Cl. B64D 25/14; B64D 45/00

(52) U.S. Cl. CPC B64D 25/14; B64D 45/00; B64D 2045/007

(57) ABSTRACT

An evacuation guidance system may comprise a plurality of floor guidance lights, a plurality of seat guidance lights, a plurality of exit signs, and a controller in communication with the plurality of floor guidance lights, the plurality of seat guidance lights, and the plurality of exit signs. The plurality of floor guidance lights may include a plurality of fore-aft floor lights and a plurality of port-starboard floor lights. The controller may be configured to determine a closest exit door to each floor guidance light, each seat guidance light, and each exit sign. The controller may command each floor guidance light, each seat guidance light, and each exit sign to indicate a direction of the closest exit door.

### CROSS-REFERENCE TO RELATED APPLICATIONS

This application claims priority to, and the benefit of, India Patent Application No. 202241024127, filed Apr. 25, 2022, (DAS Code B41E) and titled “INTELLIGENT EVACUATION GUIDANCE SYSTEM,” which is incorporated by reference herein in its entirety for all purposes.

### FIELD

The present disclosure relates generally to evacuation systems and, more particularly, to systems and methods for evacuation guidance systems.

### BACKGROUND

Aircraft evacuation systems are employed to convey passengers (i.e., evacuees) from the aircraft to an exit surface during an emergency evacuation. The time it takes for the passengers to evacuate the aircraft relies heavily on how well the crew of the aircraft communicate instructions to the passengers and the decision making of the passengers. Current evacuation guidance systems generally include various signage, lighting, audio messages, and/or other indicators configured to guide passengers to the nearest exit door. During an emergency evacuation, these indicators may be difficult to see due to smoke or other objects. Also, noise and/or difference in the language spoken by the crew versus that of a passenger can make verbal instructions from the crew or other auditory guidance difficult to hear and/or understand. Further, the door to which the lights/indicators may be guiding a passenger may not usable due to a faulty evacuation slide, blocked exit door, or other evacuation obstacle.

### SUMMARY

An evacuation guidance system is disclosed herein. In accordance with various embodiments, the evacuation guidance system may comprise a plurality of floor guidance lights, a plurality of seat guidance lights, a plurality of exit signs, and a controller in communication with the plurality of floor guidance lights, the plurality of seat guidance lights, and the plurality of exit signs. The plurality of floor guidance lights includes a plurality of fore-aft floor lights and a plurality of port-starboard floor lights. The controller is configured to determine a closest exit door to each floor guidance light of the plurality of floor guidance lights, to each seat guidance light of the plurality of seat guidance lights, and to each exit sign of the plurality of exit signs. The controller is configured to command each floor guidance light of the plurality of floor guidance lights, each seat guidance light of the plurality of seat guidance lights, and each exit sign of the plurality of exit signs to indicate a direction of the closest exit door.

In various embodiments, a plurality of inflation sensors may be in communication with the controller. Each inflation sensor of the plurality of inflation sensors may be configured to output slide sensor data correlating to an inflation state of an evacuation slide to which the inflation sensor is operably coupled. The controller may be configured to determine the closest exit door to each floor guidance light of the plurality of floor guidance lights, to each seat guidance light of the plurality of seat guidance lights, and to each exit sign of the plurality of exit signs based on the slide sensor data.

In various embodiments, a plurality of temperature sensors may be in communication with the controller. Each temperature sensor of the plurality of temperature sensors may be configured to output temperature sensor data correlating to a temperature proximate an exit door associated with the temperature sensor. The controller may be configured to determine the closest exit door to each floor guidance light of the plurality of floor guidance lights, to each seat guidance light of the plurality of seat guidance lights, and to each exit sign of the plurality of exit signs based on the temperature sensor data.

In various embodiments, a plurality of object sensors may be in communication with the controller. Each object sensor of the plurality of object sensors may be configured to output object sensor data. The controller may be configured to determine the closest exit door to each floor guidance light of the plurality of floor guidance lights, to each seat guidance light of the plurality of seat guidance lights, and to each exit sign of the plurality of exit signs based on the object sensor data.

In various embodiments, each fore-aft floor light of the plurality of fore-aft floor lights may include a forward floor light and an aft floor light, and each port-starboard floor light of the plurality of port-starboard floor lights may include a port floor light and a starboard floor light.

In various embodiments, each exit sign of the plurality of exit signs may include a port exit light and a starboard exit light. In various embodiments, each exit light of the plurality of exit signs may further include a floor-level port exit light and a floor-level starboard exit light.

In various embodiments, each seat guidance light of the plurality of seat guidance lights may include a forward seat light and an aft seat light. In various embodiments, each seat guidance light of the plurality of seat guidance lights may further include a distance indicator configured to display a number of row to the closest exit door.

An article of manufacture including a tangible, non-transitory computer-readable storage medium having instructions stored thereon for controlling a plurality of guidance components of an aircraft evacuation for guidance system is also disclosed herein. The instructions, in response to execution by a controller, cause the controller to perform operations. In accordance with various embodiments, the operations may comprise receiving, by the controller, slide sensor data from a plurality of inflation sensors; receiving, by the controller, temperature sensor data from a plurality of temperature sensors; receiving, by the controller, object sensor data from a plurality of object sensors; determining, by the controller, a status of each exit door in a plurality of exit doors based on the slide sensor data, temperature sensor data, and the object sensor data; determining, by the controller, a closest usable exit door to each guidance component of the plurality of guidance components based on the status of each exit door in the plurality of exit doors; and commanding, by the controller, each guidance component of the plurality of guidance components to indicate a direction of the closest usable exit door to the guidance component. The status of each exit door is at least one of usable or unusable.

In various embodiments, the plurality of guidance components includes a plurality of exit signs, a plurality of seat guidance lights, and a plurality of floor guidance lights. Commanding, by the controller, each guidance component of the plurality of guidance components to indicate the direction of the closest usable exit door to the guidance component may comprise sending, by the controller, an exit sign command to each exit sign of the plurality of exit signs; sending, by the controller, a seat light command to each seat guidance light of the plurality of seat guidance lights; and sending, by the controller, a floor light command to each floor guidance light of the plurality of floor guidance lights.

In various embodiments, each exit sign of the plurality of exit signs may include a port exit light and a starboard exit light. The exit sign command may be configured to control an illumination of the port exit light and the starboard exit light.

In various embodiments, each seat guidance light may include a forward seat light and an aft seat light. The seat light command may be configured to illuminate either the forward seat light or the aft seat light.

In various embodiments, each seat guidance light may further include a distance indicator. The seat light command may be configured to cause the distance indicator to display a number indicative of a number of seat rows between the seat guidance light and the closest usable exit door to the seat guidance light.

In various embodiments, the plurality of floor guidance lights may include a plurality of fore-aft floor lights. Each fore-aft floor light of the plurality of fore-aft floor lights may include a forward floor light and an aft floor light. The floor light command may be configured to illuminate either the forward floor light or the aft floor light.

In various embodiments, the plurality of floor guidance lights may further include a plurality of port-starboard floor lights. Each port-starboard floor light of the plurality of port-starboard floor lights may include a port floor light and a starboard floor light. The floor light command may be configured to control an illumination of the port floor light and the starboard floor light.

In various embodiments, determining, by the controller, the status of each exit door in the plurality of exit doors based on the slide sensor data may comprise determining, by the controller, a pressure of an evacuation slide associated with each exit door based on slide sensor data output by an inflation sensor operably coupled to the evacuation slide; and comparing, by the controller, the pressure of the evacuation slide to a threshold pressure.

A method of controlling a plurality of guidance components of an evacuation guidance system is also disclosed herein. In accordance with various embodiments, the method may comprise the steps of receiving, by a first local controller, slide sensor data from a first inflation sensor operably coupled to a first evacuation slide; receiving, by the first local controller, at least one of temperature sensor data from a first temperature sensor or object sensor data from a first object sensor; and determining, by the first local controller, a status of a first exit door based on the slide sensor data from the first inflation sensor and the least one of the temperature sensor data from the first temperature sensor or the object sensor data from the first object sensor. The method may further include the steps of receiving, by a central controller, the status of the first exit door from the first local controller; determining, by the central controller, whether the first exit door is a closest usable exit door to each guidance component of the plurality of guidance components based on the status of the first exit door; and commanding, by the central controller, each guidance component of the plurality of guidance components to indicate a direction of the closest usable exit door.

In various embodiments, the method may further comprise the steps of receiving, by a second local controller, slide sensor data from a second inflation sensor operably coupled to a second evacuation slide; receiving, by the first local controller, at least one of temperature sensor data from a second temperature sensor or object sensor data from a second object sensor; and determining, by the second local controller, a status of a second exit door based on the slide sensor data from the second inflation sensor and the least one of the temperature sensor data from the second temperature sensor or the object sensor data from the second object sensor. The method may further comprise the steps of receiving, by the central controller, the status of the second exit door from the second local controller; and determining, by the central controller, whether the second exit door is the closest usable exit door to each guidance component of the plurality of guidance components based on the status of the second exit door.

In various embodiments, the plurality of guidance components may include a plurality of exit signs, a plurality of seat guidance lights, and a plurality of floor guidance lights. Commanding, by the central controller, each guidance component of the plurality of guidance components to indicate the direction of the closest usable exit door may comprise sending, by the central controller, an exit sign command to each exit sign of the plurality of exit signs; sending, by the central controller, a seat light command to each seat guidance light of the plurality of seat guidance lights; and sending, by the central controller, a floor light command to each floor guidance light of the plurality of floor guidance lights.

The foregoing features and elements may be combined in various combinations without exclusivity, unless expressly indicated otherwise. These features and elements as well as the operation thereof will become more apparent in light of the following description and the accompanying drawings. It should be understood, however, the following description and drawings are intended to be exemplary in nature and non-limiting.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the figures, wherein like numerals denote like elements.

FIG. 1 illustrates an aircraft having an evacuation assembly, in accordance with various embodiments;

FIG. 2 illustrates an evacuation slide of an evacuation assembly in a deployed position, in accordance with various embodiments;

FIG. 3 illustrates a portion of an aircraft cabin having an intelligent evacuation guidance system, in accordance with various embodiments;

FIG. 4 illustrates floor guidance lights of an intelligent evacuation guidance system, in accordance with various embodiments;

FIG. 5 illustrate seat guidance lights of an intelligent evacuation guidance system, in accordance with various embodiments;

FIGS. 6A and 6B illustrate an exit sign of an intelligent evacuation guidance system, in accordance with various embodiments;

FIG. 7 illustrates a schematic of an intelligent evacuation guidance system, in accordance with various embodiments;

FIG. 8 illustrates an intelligent evacuation guidance system during an evacuation event, in accordance with various embodiments; and

FIG. 9 illustrates a flow chart for a method of controlling a plurality of guidance components of an evacuation guidance system, in accordance with various embodiments.

### DETAILED DESCRIPTION

The detailed description of exemplary embodiments herein makes reference to the accompanying drawings, which show exemplary embodiments by way of illustration. While these exemplary embodiments are described in sufficient detail to enable those skilled in the art to practice the exemplary embodiments of the disclosure, it should be understood that other embodiments may be realized and that logical changes and adaptations in design and construction may be made in accordance with this disclosure and the teachings herein. Thus, the detailed description herein is presented for purposes of illustration only and not limitation. The steps recited in any of the method or process descriptions may be executed in any order and are not necessarily limited to the order presented.

Furthermore, any reference to singular includes plural embodiments, and any reference to more than one component or step may include a singular embodiment or step. Also, any reference to attached, fixed, connected or the like may include permanent, removable, temporary, partial, full and/or any other possible attachment option.

Surface lines may be used throughout the figures to denote different parts but not necessarily to denote the same or different materials. Throughout the present disclosure, like reference numbers denote like elements. Accordingly, elements with like element numbering may be shown in the figures but may not necessarily be repeated herein for the sake of clarity.

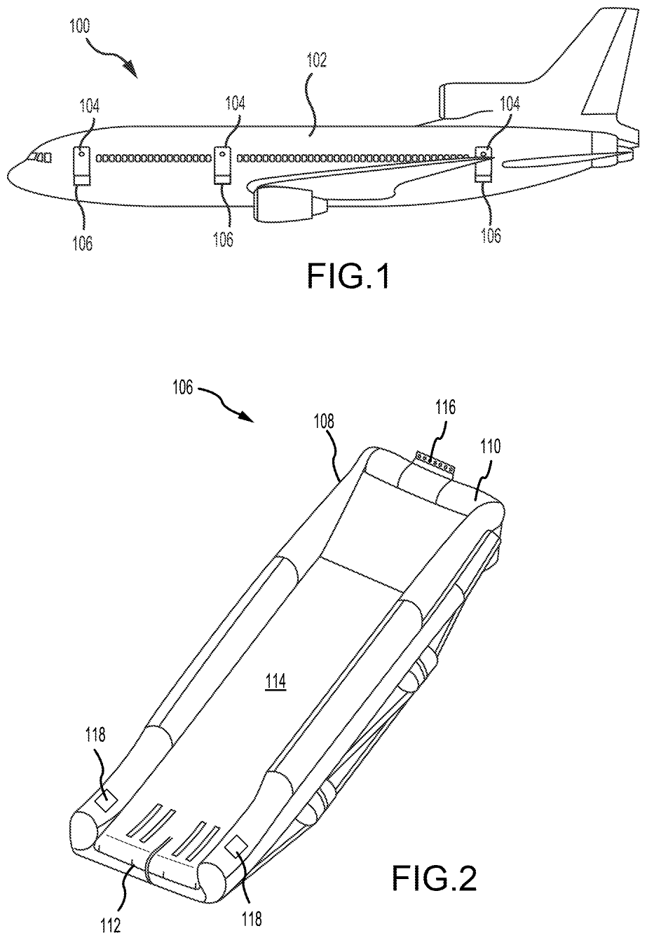

Referring now to FIG. 1, an aircraft 100 is shown. Aircraft 100 may include a fuselage 102 having a plurality of exit doors 104. Aircraft 100 may include one or more evacuation assemblies 106 positioned near a corresponding exit door 104. For example, aircraft 100 includes evacuation assemblies 106 positioned near exit doors 104. In the event of an emergency, exit door 104 may be opened by a passenger or crew member of aircraft 100. In various embodiments, each of the evacuation assemblies 106 may deploy in response its respective exit door 104 being opened. Evacuation assemblies 106 may also be configured to deploy in response to other actions taken by a passenger or crew member, such as depression of a button, actuation of a lever, etc.

With reference to FIG. 2, an evacuation assembly 106 is illustrated with an evacuation slide 108 of the evacuation assembly 106 in an inflated or “deployed” position. During deployment, evacuation slide 108 is inflated using pressurized gas from a compressed fluid source. Evacuation slide 108 may include a head end 110 and a toe end 112 opposite head end 110. A sliding surface 114 of evacuation slide 108 extends from head end 110 to toe end 112. Head end 110 may be coupled to an aircraft structure (e.g., fuselage 102 in FIG. 1) via, for example, a girt 116. Evacuation slide 108 is illustrated as a single lane slide. However, evacuation slide 108 may comprise any number of lanes. In various embodiments, evacuation slide 108 may be an over-wing evacuation slide and/or may include a ramp portion configured to extend between head end 110 and the doorway of any of exit doors 104 (FIG. 1). In various embodiments, one or more inflation sensor(s) 118 is/are operably coupled to evacuation slide 108. Inflation sensor(s) 118 may include pressure sensor(s) configured to measure a pressure of evacuation slide 108 and/or stretch sensor(s) configured to measure a stretch of the material of evacuation slide 108.

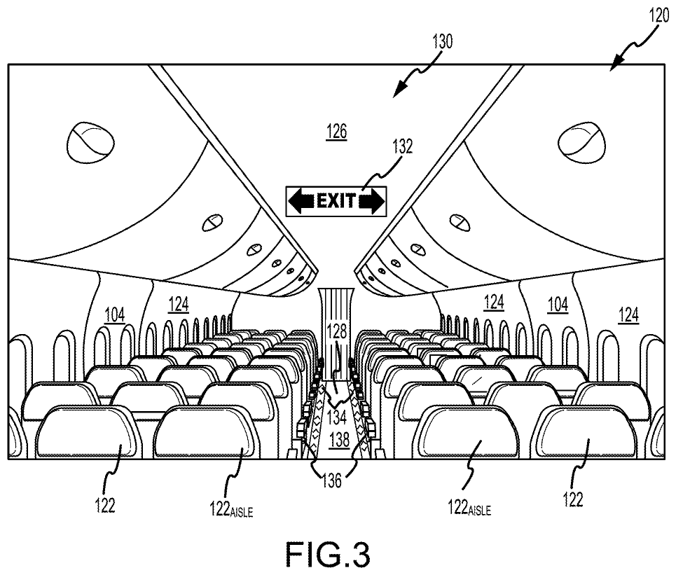

Referring now to FIG. 3, a portion of a cabin 120 of aircraft 100 (FIG. 1) is shown, according to various embodiments. A plurality of aircraft seat 122 are arranged in rows throughout cabin 120. Exit doors 104 are located along the walls 124 of cabin 120. Walls 124 extend generally between the cabin ceiling 126 and the cabin floor 128.

In accordance with various embodiments, an evacuation guidance system 130 may be installed in cabin 120. Evacuation guidance system 130 may include exit signs 132, floor guidance lights 134, and seat guidance lights 136. Exit signs 132 may be mounted to cabin ceiling 126 and/or may extend from cabin ceiling 126 downward, toward cabin floor 128. Floor guidance lights 134 may be installed along cabin floor 128 and/or in the aisle 138 between the aircraft seats 122. Seat guidance lights 136 may be installed on the sides of aircraft seats 122, and in particular, on the side of the aisle aircraft seats 122_{AISLE} that is oriented toward aisle 138. As described in further detail below, exit signs 132, floor guidance lights 134, and seat guidance lights 136 may be configured to guide evacuees to an exit door 104. In accordance with various embodiments, evacuation guidance system 130 may be an “intelligent” guidance system. In this regard, evacuation guidance system 130 may be configured to guide each evacuee to a closest exit door 104 while taking into account a deployment status of the evacuation assemblies 106 and/or other conditions in cabin 120.

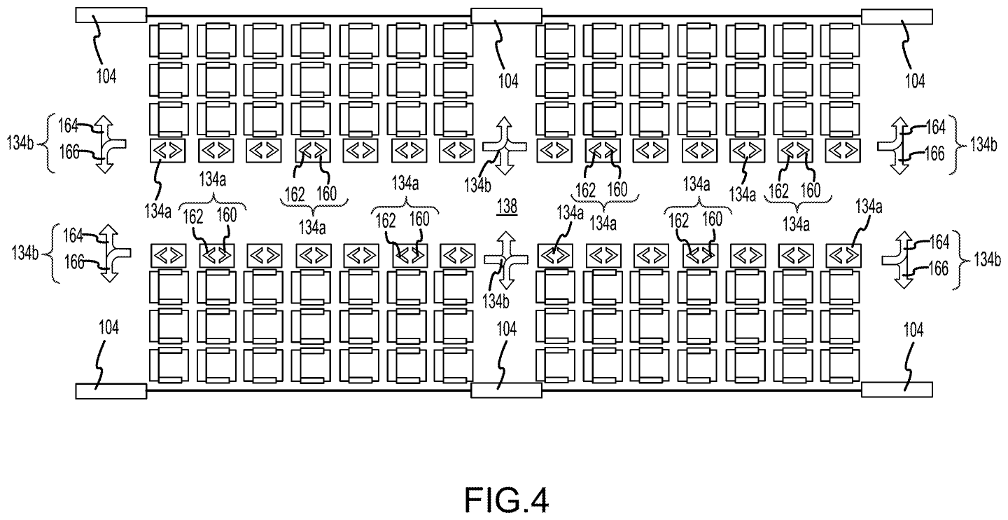

With reference to FIG. 4, in accordance with various embodiments, floor guidance lights 134 may include a series of fore-aft floor lights 134a located along aisle 138 and port-starboard floor lights 134b located at each exit door 104 (e.g., port-starboard floor lights 134b may be located in the each of the exit rows). In various embodiments, each fore-aft floor light 134a includes a forward floor light 160 and an aft floor light 162. Forward floor light 160 may be an arrow or any other symbol configured to convey to evacuees that they should travel in the forward direction. Aft floor light 162 may be an arrow or any other symbol configured to convey to evacuees that they should travel in the aft direction. In various embodiments, each port-starboard floor light 134b includes a port floor light 164 and a starboard floor light 166. Port floor light 164 may be an arrow or any other symbol configured to convey to evacuees that they should travel in the port direction. Starboard floor light 166 may be an arrow or any other symbol configured to convey to evacuees that they should travel in the starboard direction.

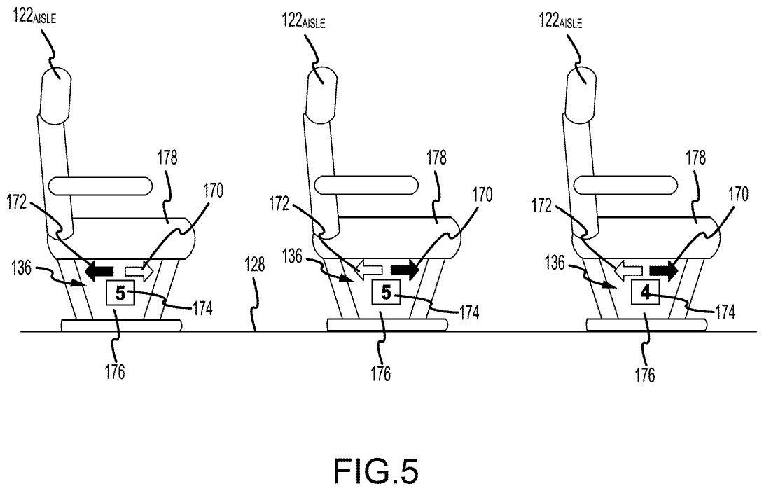

With reference to FIG. 5, in accordance with various embodiments, seat guidance lights 136 may each include a forward seat light 170 and an aft seat light 172. Forward seat light 170 may be an arrow or any other symbol configured to convey to evacuees that they should travel in the forward direction. Aft seat light 172 may be an arrow or any other symbol configured to convey to evacuees that they should travel in the aft direction. In various embodiments, seat guidance lights 136 may also, or alternatively, include a distance indicator 174. Distance indicator 174 may be configured to convey to evacuees a number of rows to the closest exit door 104. For example, the distance indicator 174 of the forwardmost aircraft seat 122 in FIG. 5 indicates that the closest exit door 104 is four (4) rows away in the forward direction (the forward direction being indicated by the illuminated forward seat light 170). The distance indicator 174 of the aftmost aircraft seat 122 in FIG. 5 indicates that the closest exit door 104 is five (5) rows away in the aft direction (the aft direction being indicated by the illuminated aft seat light 172. The distance indicator 174 of the middle aircraft seat 122 in FIG. 5 indicates that the closest exit door 104 is five (5) rows away in the forward direction (the forward direction being indicated by the illuminated forward seat light 170).

In various embodiments, seat guidance lights 136 (e.g., forward seat light 170, aft seat light 172, and distance indicator 174) may be located on a base 176 of the seat. For example, seat guidance lights 136 may be located below the seat cushion 178 (i.e., between the seat cushion 178 and the floor 128). Locating seat guidance lights 136 on base 176 tends to make seat guidance lights 136 easily viewable to evacuees that may be crawling due to smoke and/or reduce the probability that smoke within the cabin 120 will obstruct seat guidance lights 136.

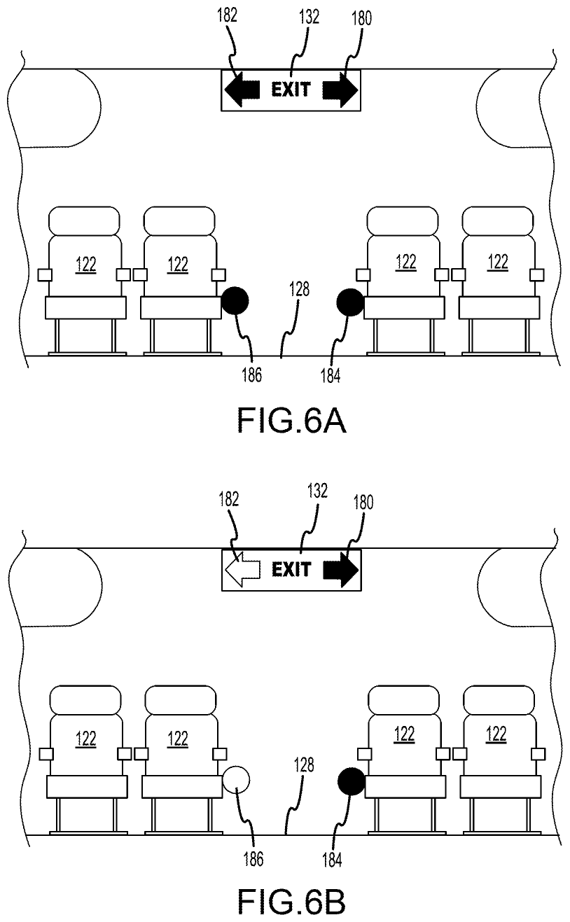

With reference to FIGS. 6A and 6B, in accordance with various embodiments, exit signs 132 may each include a port exit light 180 and a starboard exit light 182. Port exit light 180 may be an arrow or any other symbol configured to convey to evacuees that they should travel in the port direction. Starboard exit light 182 may be an arrow or any other symbol configured to convey to evacuees that they should travel in the starboard direction. In various embodiments, exit sign 132 may also include a floor-level port exit light 184 and a floor-level starboard exit light 186. Floor-level port exit light 184 and floor-level starboard exit light 186 may be located on the exit seat proximate the emergency exit row, on a wall or partition at the exit row, or any other suitable structure. Floor-level port exit light 184 and floor-level starboard exit light 186 tend to be easily viewable to evacuees that may be crawling due to smoke and/or create an alternative direction indicator for evacuees should port exit light 180 and/or starboard exit light 182 be obstructed by smoke or other objects.

In FIG. 6A, port exit light 180, starboard exit light 182, floor-level port exit light 184, and floor-level starboard exit light 186 are all illuminated, thereby indicating to evacuees that the port side exit door 104 and the starboard side exit door 104 in the exit row associated with the exit sign 132 may be used to exit the aircraft. In FIG. 6B, the port exit light 180 and floor-level port exit light 184 are illuminated, while the starboard exit light 182 and floor-level starboard exit light 186 are not illuminated, thereby indicating to evacuees that the port side exit door 104 may be used to exit the aircraft and the starboard-side exit door may not be used to exit the aircraft. In various embodiments, seat guidance lights 136 may also, or alternatively, include a distance indicator 174.

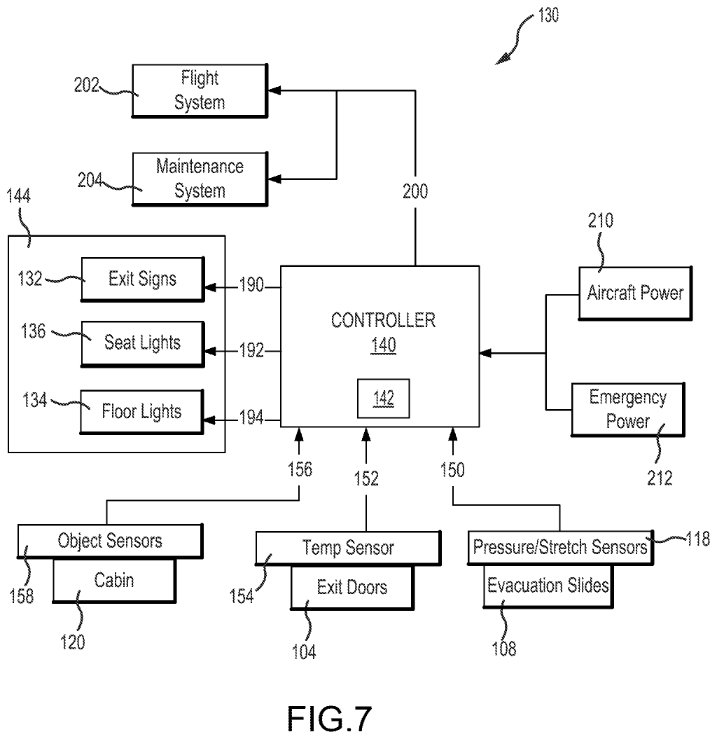

With reference to FIG. 7, a schematic of evacuation guidance system 130 is illustrated, in accordance with various embodiments. In accordance with various embodiments, evacuation guidance system 130 may be an “intelligent” guidance system. In this regard, evacuation guidance system 130 may be configured to guide evacuees to a closest exit door 104 while taking into account a deployment status of the evacuation assemblies 106 and/or other conditions in cabin 120.

In accordance with various embodiments, evacuation guidance system 130 includes a controller 140. Controller 140 may include a general-purpose processor, a digital signal processor (DSP), an application specific integrated circuit (ASIC), a field programmable gate array (FPGA) or some other programmable logic device, discrete gate or transistor logic, discrete hardware components, or any combination thereof. A tangible, non-transitory computer-readable storage medium 142 is in communication with controller 140. Storage medium 142 may comprise any tangible, non-transitory computer-readable storage medium known in the art. The storage medium 142 has instructions stored thereon that, in response to execution by controller 140, cause controller 140 to perform operations related to controlling exit signs 132, floor guidance lights 134, and seat guidance lights 136 (collectively guidance components 144) to indicate optimum exit paths through the aircraft cabin 120.

As described in further detail below, controller 140 receives sensor data correlating to the status of the various evacuation assemblies 106 of aircraft 100 and/or to various conditions within aircraft cabin 120. Based on the sensor data, controller 140 determines which exit doors 104 are accessible and which evacuation slides 108 are in a usable, properly deployed state. Controller 140 is configured to determine an optimum (e.g., shortest) exit path from each point in the cabin 120. Controller 140 may then command each of the exit signs 132, floor guidance lights 134, and seat guidance lights 136 to display (e.g., illuminate) the guidance component lights configured to convey to evacuees the optimum exit path from each point in cabin 120. In this regard, evacuation guidance system 130 provides clear visual guidance to the nearest usable emergency exit from any point in the aircraft, thereby reducing, or eliminating, a need for evacuees to communicate with crew member and/or to make assumptions regarding the direction and/or distance to the nearest usable emergency exit.

In accordance with various embodiments, controller 140 receives slide sensor data 150 from inflation sensors 118. Slide sensor data 150 correlates to an inflation status of the evacuation slide 108 to which the inflation sensor 118 is operatively coupled. Inflation sensors 118 are in communication with and output slide sensor data 150 to controller 140. The slide sensor data 150 is indicative of which inflation sensor 118/evacuation slide 108 it is from. In this regard, controller 140 is configured to determine from which inflation sensor 118 the slide sensor data 150 was received and to which evacuation slide 108 (forward port, aft starboard, wing port, etc.) the slide sensor data 150 correlates. Based on the slide sensor data 150, controller 140 determines an inflation pressure of evacuation slide 108. Controller 140 is configured to determine whether the inflation pressure is within a predetermined (e.g., safe) pressure range. In this regard, controller 140 may compare the inflation pressure to a first (or lower) pressure threshold and/or to a second (or upper) pressure threshold to determine a state of the evacuation slide 108. For example, controller 140 may determine the evacuation slide is in a properly deployed state, in response to determining the inflation pressure of evacuation slide 108 is greater than or equal to the lower threshold pressure and less than or equal to the upper pressure threshold. Controller 140 may determine the evacuation slide 108 is in a non-properly deployed state, and should not be used by evacuees, in response to determining the inflation pressure of evacuation slide 108 is less than the lower threshold pressure or greater than the upper pressure threshold.

In various embodiments, controller 140 may also receive temperature sensor data 152 from temperature sensors 154 located throughout aircraft cabin 120. In various embodiments, each temperature sensor may be associated with a particular exit door 104. In this regard, the temperature sensor data 152 correlates to a temperature proximate a particular exit door 104. Temperature sensors 154 are in communication with and output temperature sensor data 152 to controller 140. The temperature sensor data 152 is indicative of which temperature sensor 154 it is from. In this regard, controller 140 is configured to determine from which temperature sensor 154 the temperature sensor data 152 was received and to which exit door 104 (forward port, forward starboard, aft starboard, aft port, wing port, wing starboard, etc.) the temperature sensor data 152 correlates. Based on the temperature sensor data 152, controller 140 determines a temperature proximate the respective exit door or area associated with the temperature sensor 154. In this regard, controller 140 may compare the temperature to a temperature threshold to determine whether the temperature is safe for evacuees. A temperature greater than the temperature threshold may be indicative of a fire or other condition making it unsafe for evacuees to exit through a particular exit door 104. In this regard, controller 140 may determine an exit door is inaccessible, in response to determining the temperature associated with exit door is greater than the temperature threshold.

In various embodiments, controller 140 may also receive object sensor data 156 from object sensors 158 located throughout aircraft cabin 120. Object sensors 158 may include proximity sensors, cameras, infrared sensors, structured light sensors, light detection and ranging (LiDAR) sensors, an infrared sensors, depth sensors, three-dimensional scanners, radar sensors, or any other suitable sensing device. Object sensors 158 are in communication with and output object sensor data 156 to controller 140. In various embodiments, each object sensor 158 may be associated with a particular exit door 104. In various embodiments, controller 140 may be able to identify one or more exit doors 104 in the object sensor data 156 from an object sensor 158 (e.g., controller 140 may be able to identify multiple exit doors 104 in the object sensor data 156 from one camera). In accordance with various embodiments, controller 140 is configured to determine whether an obstruction is located in the path to an exit door 104 and/or whether an exit door is not open based on the object sensor data 156. For example, object sensor data 156 may indicate if an object (luggage, a fallen overhead bin, dislodged aircraft seats, etc.) is in aisle 138 and/or between aisle 138 and an exit door 104. In various embodiments, object sensor data 156 may indicate whether the door of exit door 104 is still present in the doorway. Controller 140 is configured to determine which, if any, of the exit doors 104 are inaccessible and/or unopened based on object sensor data 156. In various embodiments, one or more of object sensor(s) 158 may be mounted to the outside of the fuselage. The outside-mounted object sensors 158 are configured to detect obstructions located outside the exit door/cabin that may make the exit not usable. In this regard, controller 140 may determine whether the area outside an exit door 104 is safe for evacuees based on the object sensor data 156 output from object sensors 158 mounted outside fuselage.

Based on slide sensor data 150, temperature sensor data 152, and object sensor data 156, controller 140 determines the status of each of exit doors 104. In this regard, controller 140 may determine the status of an exit door 104 is “unusable” in response to determining the slide sensor data 150 indicates the pressure of the evacuation slide 108 associated with the exit door 104 is not within the predetermined pressure range, and/or in response to determining the temperature sensor data 152 indicates a fire, or elevated temperature, proximate the exit door 104, and/or in response to determining the object sensor data 156 indicates an obstruction in the path to the exit door 104 and/or an obstruction outside the exit door 104 and/or an unopened exit door 104. Controller 140 may determine the status of an exit door 104 is “usable” in response to determining the slide sensor data 150 indicates the pressure of the evacuation slide 108 associated with the exit door 104 is within the predetermined pressure range and in response to determining the temperature sensor data 152 and object sensor data 156 are not indicative of an anomaly (e.g., the temperature sensor data 152 is below a threshold temperature, and the object sensor data 156 indicates an unobstructed path to the exit door 104 and outside the exit door 104 and that the exit door 104 is open).

In response to the determining the status of each of the exit doors 104, controller 140 determines the closest usable exit door 104 (i.e., the closest exit door 104 having a usable status) relative to each exit sign 132, seat guidance light 136, and floor guidance light 134. In response to determining which usable exit door 104 is the closest, controller 140 determines which indicator light(s) of each guidance component 144 should be illuminated. In this regard, controller 140 determines which of port exit light 180, starboard exit light 182, floor-level port exit light 184, and/or floor-level starboard exit light 186, with momentary reference to FIG. 6A, which of forward seat light 170, aft seat light 172, and distance indicator 174, with momentary reference to FIG. 5, and which of forward floor light 160, aft floor light 162, port floor light 164, and starboard floor light 166, with momentary reference to FIG. 4, should be illuminated to convey the direction of the closest usable exit door. Controller 140 then sends exit sign commands 190 to the exit signs 132, seat light commands 192 to seat guidance lights 136, and floor light commands 194 to floor guidance lights 134.

The exit sign command 190 is configured to cause the exit sign 132 receiving the command to illuminate port exit light 180, starboard exit light 182, floor-level port exit light 184, and/or floor-level starboard exit light 186, with momentary reference to FIG. 6A. The seat light command 192 is configured to cause the seat guidance light 136 receiving the command to illuminate forward seat light 170 or aft seat light 172, with momentary reference to FIG. 5, and to cause distance indicator 174 to indicate the number of rows to the closest exit door. The floor light command 194 is configured to cause the seat guidance light 136 receiving the command to illuminate forward floor light 160 or aft floor light 162, for fore-aft floor lights 134a, with momentary reference to FIG. 4, or to illuminate port floor light 164 or starboard floor light 166, for port-starboard floor lights 134b, with momentary reference to FIG. 4.

Controller 140 may be configured to send data 200 (e.g., real-time data) to an aircraft flight warning system 202. Aircraft flight warning system 202 may be configured to alert the crew and/or to convey to the crew of the status of each emergency exit (active/inactive) and/or of any anomalies (e.g., obstruction, improperly inflated evacuation slides, unopened exit doors, general system failures, lighting failures, etc.) detected. In various embodiments, controller 140 may also send data 200 to an aircraft maintenance system 204 for fault logging.

In various embodiments, controller 140 may be electrically connected to and may receive power from an aircraft power supply 210. In various embodiments, controller 140 may also, or alternatively, be electrically connected to and may receive power from an emergency power supply 212. Emergency power supply 212 may be configured to activate (e.g., begin supplying power) in response to an evacuation event. Emergency power supply 212 may be configured to supply power independently of aircraft power supply 210. Being connected to both aircraft power supply 210 and emergency power supply 212 provides a redundancy should either power supply be unavailable.

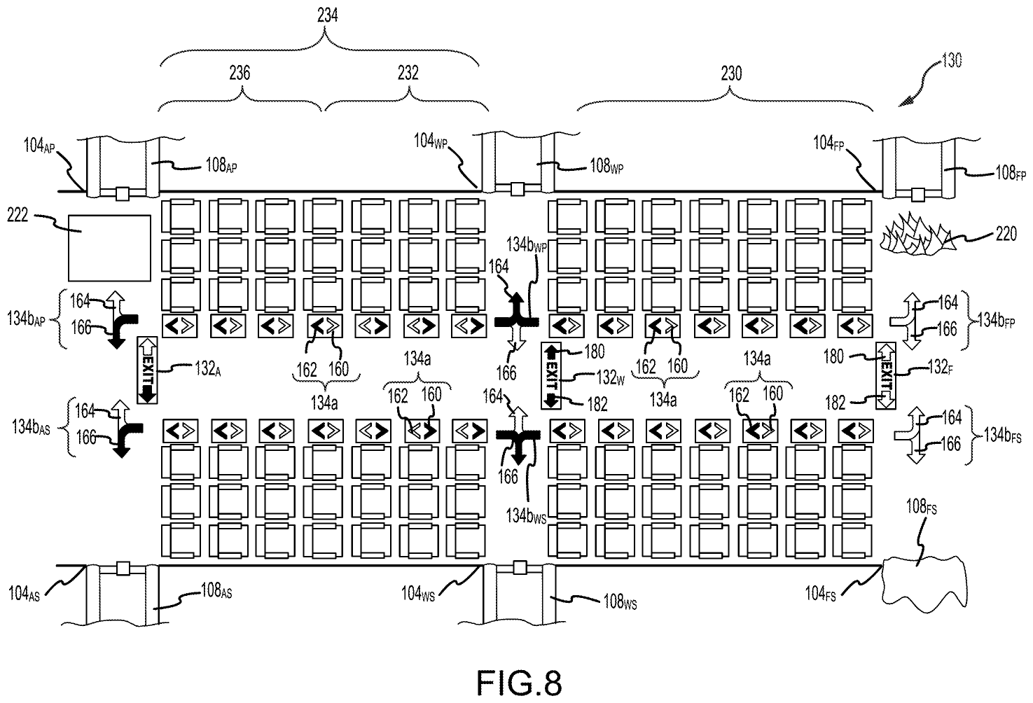

With reference to FIG. 8, evacuation guidance system 130 is shown during an exemplary evacuation event of aircraft 100. In FIG. 8, a fire 220 is located proximate forward port exit door 104_{FP}, forward starboard evacuation slide 108_{FS} is underinflated, and an obstruction 222 is located proximate aft port exit door 104_{AP}. With combined reference to FIG. 8 and FIG. 7, in response to the evacuation event, controller 140 determines the status of forward port exit door 104_{FP} is unusable based on temperature sensor data 152 output from a temperature sensor 154 associated with forward port exit door 104_{FP}. Controller 140 determines the status of forward starboard exit door 104_{FS} is unusable based on slide sensor data 150 output from an inflation sensor 118 associated with forward starboard evacuation slide 108_{FS}.

Controller 140 determines the status of wing port exit door 104_{WP} is usable based on slide sensor data 150 output from an inflation sensor 118 associated with wing port evacuation slide 108_{WP}, based on temperature sensor data 152 output from a temperature sensor 154 associated with wing port exit door 104_{WP}, and based on object sensor data 156 output from an object sensor 158 associated with wing port side door 104_{WP}. Controller 140 determines the status of wing starboard exit door 104_{WS} is usable based on slide sensor data 150 output from an inflation sensor 118 associated with wing starboard evacuation slide 108_{WS}, based on temperature sensor data 152 output from a temperature sensor 154 associated with wing starboard exit door 104_{WS}, and based on object sensor data 156 output from an object sensor 158 associated with wing starboard side door 104_{WS}.

Controller 140 determines the status of aft starboard exit door 104_{AS} is usable based on slide sensor data 150 output from an inflation sensor 118 associated with aft starboard evacuation slide 108_{AS}, based on temperature sensor data 152 output from a temperature sensor 154 associated with aft starboard exit door 104_{AS}, and based on object sensor data 156 output from an object sensor 158 associated with aft starboard exit door 104_{AS}. Controller 140 determines the status of aft port exit door 104_{AP} is unusable based on object sensor data 156 output from an object sensor 158 associated with aft port exit door 104_{AP}.

Based on the unusable status of each of forward port exit door 104_{FP} and forward starboard exit door 104_{FS} and the usable status of each of wing port exit door 104_{WP} and wing starboard exit door 104_{WS}, controller 140 determines that wing port side door 104_{WP} and wing starboard side door 104_{WS} are the closest exit doors to the forward exit sign 132_{F}, to the wing exit sign 132W, to all of the fore-aft floor lights 134a in a forward section 230 of the cabin 120, to a forward group 232 of fore-aft floor lights 134a located in aft section 234 of the cabin 120, to the forward port side port-starboard floor light 134b_{FP}, to the forward starboard side port-starboard floor light 134b_{FS}, to wing port side port-starboard floor light 134b_{WP}, and to the wing starboard side port-starboard floor light 134b_{WS}.

In response to determining that wing port side door 104_{WP} and wing starboard side door 104_{WS} are the closest exit doors to forward exit sign 132_{F}, controller 140 commands forward exit sign 132_{F} maintain each of port exit light 180 and starboard exit light 182 in an “off” or not illuminated state. In various embodiments, controller 140 maintains each of port exit light 180 and starboard exit light 182 in the off state by not sending an exit sign command 190 to forward exit sign 132_{F}. In response to determining that wing port side door 104_{WP} and wing starboard side door 104_{WS} are the closest exit doors to wing exit sign 132_{W}, controller 140 commands wing exit sign 132_{W} to illuminate both port exit light 180 and starboard exit light 182.

In response to determining that wing port side door 104_{WP} and wing starboard side door 104_{WS} are the closest exit doors to the fore-aft floor lights 134a in forward section 230, controller 140 commands each of the fore-aft floor lights 134a in forward section 230 to illuminate its aft floor light 162. In response to determining that wing port side door 104_{WP} and wing starboard side door 104_{WS} are the closest exit doors to the forward group 232 of fore-aft floor lights 134a, controller 140 commands the forward group 232 of fore-aft floor lights 134a in aft section 234 to illuminate its forward floor light 160.

In response to determining that wing port side door 104_{WP} and wing starboard side door 104_{WS} are the closest exit doors to forward port side port-starboard floor light 134b_{FP} and the forward starboard side port-starboard floor light 134b_{FS}, controller 140 commands each of the forward port side port-starboard floor light 134b_{FP} and the forward starboard side port-starboard floor light 134b_{FS} to maintain its the port floor light 164 and starboard indicator lights 166 an “off” or not illuminated state. In various embodiments, controller 140 maintains the port floor lights 164 and starboard indicator lights 166 in the off state by not sending a floor light command 194 to either of forward port side port-starboard floor light 134b_{FP} or forward starboard side port-starboard floor light 134b_{FS}.

In response to determining that wing port side door 104_{WP} and wing starboard side door 104_{WS} are the closest exit doors to wing port side port-starboard floor light 134b_{WP}, controller 140 commands the wing port side port-starboard floor light 134b_{WP} to illuminate port floor light 164. In response to determining that wing port side door 104_{WP} and wing starboard side door 104_{WS} are the closest exit doors to wing starboard side port-starboard floor light 134b_{WP}, controller 140 commands the wing starboard side port-starboard floor light 134b_{WP} to illuminate starboard floor light 166.

Based on the unusable status of each of forward port exit door 104_{FP} and forward starboard exit door 104_{FS} and the usable status of each of wing port exit door 104_{WP} and wing starboard exit door 104_{WS}, controller 140 also determines that wing port exit door 104_{WP} and wing starboard exit door 104_{WS} are the closest exit doors to each of the seat guidance lights 136 in forward section 230 and to each of the seat guidance lights 136 in the forward group 232 of seats guidance lights 136 in aft section 234.

With momentary additional reference to FIG. 5, in response to determining that wing port side door 104_{WP} and wing starboard side door 104_{WS} are the closest exit doors to the seat guidance lights 136 in forward section 230, controller 140 commands each of the seat guidance lights 136 in forward section 230 to illuminate its aft seat light 172 and to display on its distance indicator 174 the number of rows to wing port side door 104_{WP} and wing starboard side door 104_{WS}. In response to determining that wing port side door 104_{WP} and wing starboard side door 104_{WS} are the closest exit doors to the seat guidance lights 136 in forward group 232, controller 140 commands each of the seat guidance lights 136 in the forward group 232 of seat guidance light 136 in aft section 234 to illuminate its forward seat light 170 and to display on its distance indicator 174 the number of rows to wing port side door 104_{WP} and wing starboard side door 104_{WS}.

Based on the unusable status of aft port exit door 104_{AP} and the usable status of aft starboard exit door 104_{AS}, controller 140 determines that aft starboard exit door 104_{AS} is the closest exit door to the aft exit sign 132A, to an aft group 236 of fore-aft floor lights 134a located in aft section 234 of the cabin 120, to the aft port side port-starboard floor light 134a_{AP}, and to the aft starboard side port-starboard floor light 134b_{AS}.

In response to determining aft starboard exit door 104_{AS} is the closest exit door to aft exit sign 132A, controller 140 commands aft exit sign 132_{A} to illuminate starboard exit light 182 and to maintain port exit light 180 and in an “off” or not illuminated state. In response to determining aft starboard exit door 104_{AS} is the closest exit door to the aft group 236 of fore-aft floor lights 134a, controller 140 commands each of the fore-aft floor light 134a in the aft group 236 of the fore-aft floor lights 134a in aft section 234 to illuminate its aft floor light 162. In response to determining aft starboard exit door 104_{AS} is the closest exit door to the aft port side port-starboard floor light 134a_{AP}, controller 140 commands the aft port side port-starboard floor light 134a_{AP} to illuminate starboard floor light 166. In response to determining aft starboard exit door 104_{AS} is the closest exit door to the aft starboard side port-starboard floor light 134b_{AS}, controller 140 commands the aft starboard side port-starboard floor light 134b_{AS} to illuminate starboard floor light 166.

Based on the unusable status of aft port exit door 104_{AP} and the usable status of aft starboard exit door 104_{AS}, controller 140 also determines that aft starboard side door 104_{AS} is the closest exit door to each of the seat guidance lights 136 in the aft group 236 of the seat guidance lights 136 in aft section 234. With momentary additional reference to FIG. 5, in response to determining that aft starboard side door 104_{AS} is the closest exit door to of the seat guidance lights 136 in aft group 236, controller 140 commands each of the seat guidance lights 136 in the aft group 236 of seat guidance light 136 in aft section 234 to illuminate its aft seat light 172 and to display on its distance indicator 174 the number of rows to aft starboard exit door 104_{AS}.

Evacuation guidance system 130 provides clear visual guidance to the nearest usable emergency exit from any point in the aircraft cabin 120. In this regard, evacuation guidance system 130 reduces, or eliminates, a need for evacuees to communicate with crew members and/or to make decisions regarding the direction and/or distance to the nearest usable emergency exit.

While evacuation guidance system 130 is described with controller 140 being a centralized controller that is configured to determine the status of all of the exit doors based on the sensor data received by the controller 140, it is further contemplated and understood that in various embodiments, controller 140 may be in communication with a plurality of distributed controllers. For example, in various embodiments, a local controller may be associated with each exit door 104 and may receive sensor data 150, 152, 156 from the sensors 118, 154, 158 associated with its respective exit door 104. Each of the local controllers is configured to determine a status of its respective exit door 104 based on the received sensor data 150, 152, 156. Controller 140 receives the door status from each of the local controllers. Controller 140 determines the closest usable exit door relative to each exit sign 132, seat guidance light 136, and floor guidance light 134 based on the door statuses received from the local controllers. Controller 140 then sends commands 190, 192, 194 to the exit signs 132, seat guidance lights 136, and floor guidance lights 134, respectively, thereby causing the exit signs 132, seat guidance lights 136, and floor guidance lights 134 to illuminate the exit signs, seat light, or floor light indicator light corresponding with the direction (or distance) to the closest exit door 104.

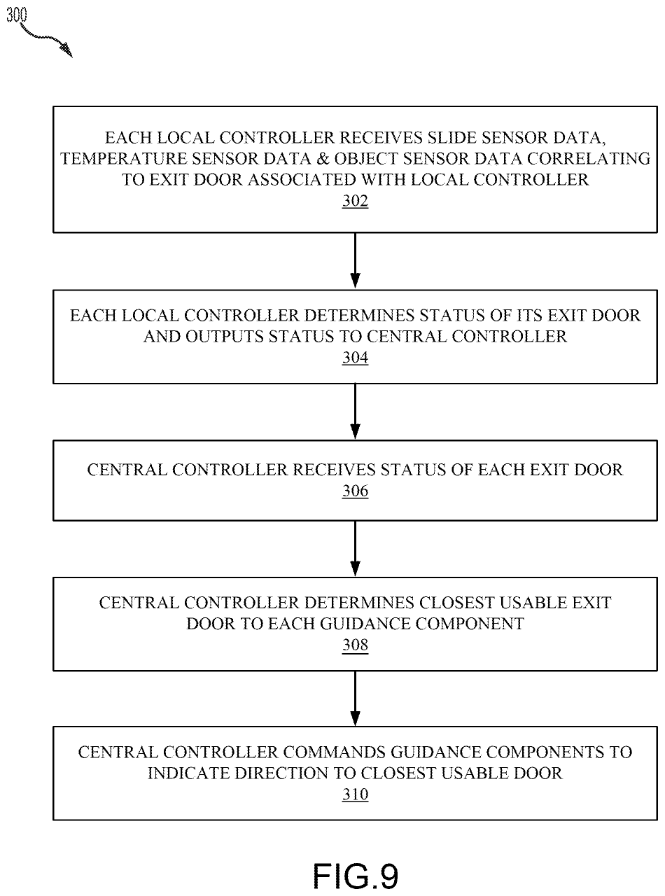

With reference to FIG. 9, a method 300 of controlling a plurality of guidance components of an evacuation guidance system is illustrated. In accordance with various embodiments, method 300 may include a plurality of local controllers each receiving slide sensor, temperature sensor data, and/or object sensor data and correlating to an evacuation slide and exit door with which the local controller is associated (step 302). Each local controller may determine a status of its respective door based on the slide sensor, temperature sensor data, and/or object sensor data received by the local controller (step 304). Method 300 may further a central controller receiving the status of each exit door from the exit door's respective local controller (step 306). The central controller may determine a closest usable exit door to each guidance component of the plurality of guidance components based on the exit door statuses received from local controller (step 308). The central controller may command each guidance component of the plurality of guidance components to indicate a direction of the closest usable exit door (step 310).

In various embodiments, step 302 may include receiving, by a first local controller, slide sensor data from a first inflation sensor operably coupled to a first evacuation slide; and receiving, by the first local controller, at least one of temperature sensor data from a first temperature sensor or object sensor data from a first object sensor. In various embodiments, step 304 may include determining, by the first local controller, a status of a first exit door based on the slide sensor data from the first inflation sensor and the least one of the temperature sensor data from the first temperature sensor or the object sensor data from the first object sensor. In various embodiments, step 306 may include receiving, by a central controller, the status of the first exit door from the first local controller. Step 308 may include determining, by the central controller, whether the first exit door is the closest usable exit door to each guidance component of the plurality of guidance components based on the status of the first exit door. Step 310 may include commanding, by the central controller, each guidance component of the plurality of guidance components to indicate a direction of the closest usable exit door.

In various embodiments, step 302 may further include receiving, by a second local controller, slide sensor data from a second inflation sensor operably coupled to a second evacuation slide; and receiving, by the first local controller, at least one of temperature sensor data from a second temperature sensor or object sensor data from a second object sensor. In various embodiments, step 304 may further include determining, by the second local controller, a status of a second exit door based on the slide sensor data from the second inflation sensor and the least one of the temperature sensor data from the second temperature sensor or the object sensor data from the second object sensor. In various embodiments, step 306 may further include receiving, by the central controller, the status of the second exit door from the second local controller, and step 308 may further include determining, by the central controller, whether the second exit door is the closest usable exit door to each guidance component of the plurality of guidance components based on the status of the second exit door.

In various embodiments, the plurality of guidance components includes a plurality of exit signs, a plurality of seat guidance lights, and a plurality of floor guidance lights, and step 310 may include sending, by the central controller, an exit sign command to each exit sign of the plurality of exit signs; sending, by the central controller, a seat light command to each seat guidance light of the plurality of seat guidance lights; and sending, by the central controller, a floor light command to each floor guidance light of the plurality of floor guidance lights.

Benefits and other advantages have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, and any elements that may cause any benefit or advantage to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

Systems, methods, and apparatus are provided herein. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is intended to invoke 35 U.S.C. 112(f), unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed:

1. An evacuation guidance system, comprising:
a plurality of floor guidance lights, the plurality of floor guidance lights including a plurality of fore-aft floor lights and a plurality of port-starboard floor lights;
a plurality of seat guidance lights;
a plurality of exit signs; and
a controller in communication with the plurality of floor guidance lights, the plurality of seat guidance lights, and the plurality of exit signs, wherein the controller is configured to determine a closest exit door to each floor guidance light of the plurality of floor guidance lights, to each seat guidance light of the plurality of seat guidance lights, and to each exit sign of the plurality of exit signs, and wherein the controller is configured to command each floor guidance light of the plurality of floor guidance lights, each seat guidance light of the plurality of seat guidance lights, and each exit sign of the plurality of exit signs to indicate a direction of the closest exit door.

2. The evacuation guidance system of claim 1, further comprising a plurality of inflation sensors in communication with the controller, wherein each inflation sensor of the plurality of inflation sensors is configured to output slide sensor data correlating to an inflation state of an evacuation slide to which the inflation sensor is operably coupled, and wherein the controller is configured to determine the closest exit door to each floor guidance light of the plurality of floor guidance lights, to each seat guidance light of the plurality of seat guidance lights, and to each exit sign of the plurality of exit signs based on the slide sensor data.

3. The evacuation guidance system of claim 2, further comprising a plurality of temperature sensors in communication with the controller, wherein each temperature sensor of the plurality of temperature sensors is configured to output temperature sensor data correlating to a temperature proximate an exit door associated with the temperature sensor, and wherein the controller is configured to determine the closest exit door to each floor guidance light of the plurality of floor guidance lights, to each seat guidance light of the plurality of seat guidance lights, and to each exit sign of the plurality of exit signs based on the temperature sensor data.

4. The evacuation guidance system of claim 3, further comprising a plurality of object sensors in communication with the controller, wherein each object sensor of the plurality of object sensors is configured to output object sensor data, and wherein the controller is configured to determine the closest exit door to each floor guidance light of the plurality of floor guidance lights, to each seat guidance light of the plurality of seat guidance lights, and to each exit sign of the plurality of exit signs based on the object sensor data.

5. The evacuation guidance system of claim 2, wherein each fore-aft floor light of the plurality of fore-aft floor lights includes a forward floor light and an aft floor light, and wherein each port-starboard floor light of the plurality of port-starboard floor lights includes a port floor light and a starboard floor light.

6. The evacuation guidance system of claim 5, wherein each exit sign of the plurality of exit signs includes a port exit light and a starboard exit light.

7. The evacuation guidance system of claim 6, wherein each seat guidance light of the plurality of seat guidance lights includes a forward seat light and an aft seat light.

8. The evacuation guidance system of claim 7, wherein each seat guidance light of the plurality of seat guidance lights further includes a distance indicator configured to display a number of row to the closest exit door.

9. The evacuation guidance system of claim 8, wherein each exit light of the plurality of exit signs further includes a floor-level port exit light and a floor-level starboard exit light.

10. An article of manufacture including a tangible, non-transitory computer-readable storage medium having instructions stored thereon for controlling a plurality of guidance components of an aircraft evacuation for guidance system and that, in response to execution by a controller, cause the controller to perform operations, the operations comprising:
receiving, by the controller, slide sensor data from a plurality of inflation sensors;
receiving, by the controller, temperature sensor data from a plurality of temperature sensors;
receiving, by the controller, object sensor data from a plurality of object sensors;
determining, by the controller, a status of each exit door in a plurality of exit doors based on the slide sensor data, temperature sensor data, and the object sensor data, the status of each exit door being at least one of usable or unusable;
determining, by the controller, a closest usable exit door to each guidance component of the plurality of guidance components based on the status of each exit door in the plurality of exit doors; and
commanding, by the controller, each guidance component of the plurality of guidance components to indicate a direction of the closest usable exit door to the guidance component.

11. The article of claim 10, wherein the plurality of guidance components includes a plurality of exit signs, a plurality of seat guidance lights, and a plurality of floor guidance lights, wherein commanding, by the controller, each guidance component of the plurality of guidance components to indicate the direction of the closest usable exit door to the guidance component comprises:
sending, by the controller, an exit sign command to each exit sign of the plurality of exit signs;
sending, by the controller, a seat light command to each seat guidance light of the plurality of seat guidance lights; and
sending, by the controller, a floor light command to each floor guidance light of the plurality of floor guidance lights.

12. The article of claim 11, wherein each exit sign of the plurality of exit signs includes a port exit light and a starboard exit light, and wherein the exit sign command is configured to control an illumination of the port exit light and the starboard exit light.

13. The article of claim 11, wherein each seat guidance light includes a forward seat light and an aft seat light, and wherein the seat light command is configured to illuminate either the forward seat light or the aft seat light.

14. The article of claim 13, wherein each seat guidance light further includes a distance indicator, and wherein the seat light command is configured to cause the distance indicator to display a number indicative of a number of seat rows between the seat guidance light and the closest usable exit door to the seat guidance light.

15. The article of claim 11, wherein the plurality of floor guidance lights includes a plurality of fore-aft floor lights, each fore-aft floor light of the plurality of fore-aft floor lights including a forward floor light and an aft floor light, and wherein the floor light command is configured to illuminate either the forward floor light or the aft floor light.

16. The article of claim 15, wherein the plurality of floor guidance lights further includes a plurality of port-starboard floor lights, each port-starboard floor light of the plurality of port-starboard floor lights including a port floor light and a starboard floor light, and wherein the floor light command is configured to control an illumination of the port floor light and the starboard floor light.

17. The article of claim 10, wherein determining, by the controller, the status of each exit door in the plurality of exit doors based on the slide sensor data comprises:
determining, by the controller, a pressure of an evacuation slide associated with each exit door based on slide sensor data output by an inflation sensor operably coupled to the evacuation slide; and
comparing, by the controller, the pressure of the evacuation slide to a threshold pressure.

18. A method of controlling a plurality of guidance components of an evacuation guidance system, the method comprising:
receiving, by a first local controller, slide sensor data from a first inflation sensor operably coupled to a first evacuation slide;
receiving, by the first local controller, at least one of temperature sensor data from a first temperature sensor or object sensor data from a first object sensor;
determining, by the first local controller, a status of a first exit door based on the slide sensor data from the first inflation sensor and the least one of the temperature sensor data from the first temperature sensor or the object sensor data from the first object sensor;
receiving, by a central controller, the status of the first exit door from the first local controller;
determining, by the central controller, whether the first exit door is a closest usable exit door to each guidance component of the plurality of guidance components based on the status of the first exit door; and
commanding, by the central controller, each guidance component of the plurality of guidance components to indicate a direction of the closest usable exit door.

19. The method of claim 18, further comprising:
receiving, by a second local controller, slide sensor data from a second inflation sensor operably coupled to a second evacuation slide;
receiving, by the first local controller, at least one of temperature sensor data from a second temperature sensor or object sensor data from a second object sensor;
determining, by the second local controller, a status of a second exit door based on the slide sensor data from the second inflation sensor and the least one of the temperature sensor data from the second temperature sensor or the object sensor data from the second object sensor;
receiving, by the central controller, the status of the second exit door from the second local controller; and
determining, by the central controller, whether the second exit door is the closest usable exit door to each guidance component of the plurality of guidance components based on the status of the second exit door.

20. The method of claim 19, wherein the plurality of guidance components includes a plurality of exit signs, a plurality of seat guidance lights, and a plurality of floor guidance lights, and wherein commanding, by the central controller, each guidance component of the plurality of guidance components to indicate the direction of the closest usable exit door comprises:
sending, by the central controller, an exit sign command to each exit sign of the plurality of exit signs;
sending, by the central controller, a seat light command to each seat guidance light of the plurality of seat guidance lights; and
sending, by the central controller, a floor light command to each floor guidance light of the plurality of floor guidance lights.
